(19) United States
(12) Patent Application Publication
(10) Pub. No.: US 2025/0229422 A1
(43) Pub. Date: Jul. 17, 2025

(54) SYSTEM AND A METHOD FOR CONTROLLING A ROBOT POSE IN A ROOM

(71) Applicant: DEUS ROBOTICS INC, Dover, DE (US)

(72) Inventor: Pavlo PIKULIN, Kyiv (UA)

(21) Appl. No.: 18/410,973

(22) Filed: Jan. 11, 2024

(51) Int. Cl. B25J 9/16; B25J 13/08; G05D 105/28

(52) U.S. Cl. CPC B25J 9/1666; B25J 9/1674; B25J 13/089; G05D 2105/28

(57) ABSTRACT

A group of inventions relates to a field of robotic engineering, in particular, to a system and a method for controlling a robot pose in a room, e.g., in a storage room when using robots for moving various storage containers.

A system for controlling a robot pose in a room is provided, the system comprises a navigation map creation module for creating a navigation map that corresponds to an interior of the room and is for at least one robot that is configured to alter its pose in the room according to the created navigation map, a location control module for controlling a location of at least one robot in the room, the module is configured to receive a data from markers located in the room according to the created navigation map, as well as a data received by at least one sensor mounted in the robot upon its interaction with at least one marker, and a user-system interaction module that is configured to enable an interaction between a user and the navigation map creation module and the location control module for controlling the location of at least one robot in the room, wherein the navigation map creation module is configured to receive an input data about the room from the user via the user-system interaction module, to process the received data and to create a navigation map based on results of this processing using artificial intelligence (AI) algorithms. Also, a control of the robot pose in the room is provided.

A group of inventions relates to a field of robotic engineering, in particular, to a system and a method for controlling a robot pose in a room, e.g., in a storage room when using robots for moving various storage containers.

At this development stage of the field, almost each manufacturer of robots has its own system for controlling a robot pose in a room that is usually provided for use when purchasing/renting the robots. At the same time, the manufacturers develop said control systems based on characteristics and existing types of their robots. Some systems for controlling the robot pose in the room enable to simultaneously control of only one type of the robots, while some of them enable to control different types of the robots.

International application WO2022105024 teaches a method and a device for determining a pose of a robot, and it teaches, inter alia, a camera of the robot for acquiring two-dimensional code images such as QR-code, an inertial sensor of the robot such as IMU sensor for measuring the pose at three axes, angular velocity and acceleration of an object, which comprises accelerometers and gyroscopes, a wheeled odometer and use of an extended Kalman filter algorithm that may receive several data types. This invention is intended to increase a positioning accuracy of the robot pose in a complex environment.

Korean patent KR102041664 teaches a method and a device for controlling a pose of a robot in a room by means of information about QR-marker that is located within an interior of the room and information received by a sensor mounted in the robot. The at least one sensor mounted in the robot may include at least one of sensors of odometry, gyroscope, light detection and ranging (LIDAR) or a camera. The device for controlling the robot pose in the room for recognizing a location of the robot receives information about the QR-marker and information perceived by the sensor of the robot in order to obtain a display result by means of a display algorithm. The display algorithm may include a plot generator, an optimizer and a generator of a navigation map. The navigation map generator registers several initial QR-markers and automatically registers the rest of the markers for quick and effective creation of the map. It further comprises a filter for filtrating a calculated position of the robot by means of a particulate filter.

Drawbacks of the prior art solutions may include a lack of possibility of consideration of alternations that take place in a manufacturing/warehousing process, new robots or equipment, or adding, to the system, a detailed data about the room, scaling complexity, since the existing algorithms are not always adapted to implement several parallel control processes. Also, the described systems for controlling the robot pose in the room are rather complex to use and often require special knowledge and skills of an operating personnel, e.g., knowledge of main principles of building the navigation maps for movement of the robots, knowledge of technical characteristics of the robots, skills in the manual control of the robots, programming skills if the integration with third-party control systems is required.

Therefore, the claimed invention is aimed at provision of a system for controlling a robot pose in a room having a set of interrelated elements that would allow to provide achievement of a technical effect being a simplification of interaction between a user, the system and robots, a provision of its flexibility if a quick adaptation to any alterations of an operation process is needed.

Another aim of the claimed invention is to provide a method for controlling a robot pose in a room having a combination of steps, while said combination and the set of the interrelated elements of the system used for its implementation would allow to provide the achievement of the above-mentioned technical effect.

The posed aim is achieved by providing a system for controlling a robot pose in a room, the system comprises a navigation map creation module for creating a navigation map that corresponds to an interior of the room and is for at least one robot that is configured to alter its pose in the room according to the created navigation map, a location control module for controlling a location of at least one robot in the room, the module is configured to receive a data from markers located in the room according to the created navigation map, as well as a data received by at least one sensor mounted in the robot upon its interaction with at least one marker, and a user-system interaction module that is configured to enable an interaction between a user and the navigation map creation module and the location control module for controlling the location of at least one robot in the room, wherein the navigation map creation module is configured to receive an input data about the room from the user via the user-system interaction module, to process the received data and to create the navigation map based on results of this processing using artificial intelligence (AI) algorithms.

Another aim is achieved by providing a method for controlling a robot pose in a room by means of the above-described system, the method comprises steps of creating, by means of a navigation map creation module, a navigation map that corresponds to an interior of the room and is for at least one robot that is configured to alter its pose in the room according to the created navigation map, controlling, by means of a location control module for controlling a location of at least one robot in the room, a location of at least one robot in the room by receiving a data from markers located in the room according to the created navigation map, as well as a data received by at least one sensor mounted in the robot upon its interaction with at least one marker, and by comparing this data to the created navigation map, wherein each step comprises enabling a user interaction with the navigation map creation module and with the location control module for controlling the location of at least one robot in the room by means of a user-system interaction module, and the step of creating the navigation map comprises enabling receiving an input data about the room from the user, processing the received data and creating the navigation map based on results of this processing using AI algorithms by means of the navigation map creation module.

According to a preferable embodiment of the invention, the room is a storage room, and the robot is configured to alter its pose in the storage room to move storage containers. In this case, the storage containers mean containers, stacks, pallets, boxes, platforms etc.

Owing to the possibility of receiving the input data about the room from the user, as well as owing to the use of the AI algorithms for processing the data at various stages of implementation of the invention, it is allowed to simplify the interaction between the user and the system, and, thus, the robots, since in this case, the user is not required to have any special knowledge in a field of building of navigation maps in order to enable movement of the robots in the room with consideration of all possible details such as a structure of a building, characteristics of the robots, a mandatory planning of the most optimal arrangement of the equipment, storage containers etc., knowledge about technical characteristics of the robots, mandatory skills in manual control of the robots, instead it is required to merely use a friendly interface of the user-system interaction module in order to input the corresponding input data which then will be processed using the AI algorithms in order to create the most optimal navigation map to allow movement of the robots and the overall functioning of the system. Also, creation of the navigation map using the AI algorithms by means of the navigation map creation module allows to provide the system flexibility that enables to adapt to any alterations of the operation process if needed. This embodiment of the invention enables to perform quick and flexible alteration of the system configuration in order to adapt to alterations of business requirements, to easily scale dimensions and load of the storage room or manufacturing by adding robots, storage containers, unloading or loading points, to change locations of any pieces of equipment, e.g., charging stations for the robots, scanners, conveyors etc. If the load is increased, the system will automatically consume more server resources which allows to provide a high speed of the system reaction during scaling the manufacturing process or storage.

According to another embodiment of the invention, the system comprises a third-party control systems integration module that is configured to enable the user to input an input data and to receive an output data from third-party control systems. Owing to the simple and user-friendly interface of the module that consists of a set of various menus and input fields which enable the user to select or to input the input data serving as a basis for automatic formation of a request with the corresponding parameters to the third-party control system, as well as determines a format of a response to be received to this request, the system allows to easily and quickly integrate with various warehouse or manufacturing facility control systems, and in this embodiment, the described actions may be performed by the operating personnel without any programming skills.

Also, in a preferable embodiment of the invention, the input data about the room is selected from a group comprising at least one of a room plan, room structural elements, a desired area of the room, where the movement of the robots is allowed, a desired area of the room for arranging an additional equipment, a number and dimensions of the storage containers, a number and dimensions of the additional equipment, a type and dimensions of the robots, desired safety parameters. Therefore, when starting interacting with the system, the user may upload the room plan, to add the structural elements which are arranged within the area, where the movement of the robots is allowed, e.g., a wall, footprints of the building, elevator shafts, stationary equipment, slits in the walls, stairwells etc. The desired area of the room, where the movement of the robots is allowed, the desired area of the room for arrangement of the storage containers and the desired area of the room for arrangement of the additional equipment may be indicated by the user, e.g., by delineating a desired area on the uploaded plan by means of contour rectangular lines. All said types of the room area may intersect with each other. The desired safety parameters shall mean safe distances which are required for providing safe traffic of the robots, i.e., these are additional distances which are added to the dimensions of the robot and intended to provide a non-interrupted movement of the robot in case of its deviation during driving from a center of the built path.

According to another preferable embodiment of the invention, the navigation map creation module comprises a file management sub-module that is configured to upload files about the room during receiving the input data about the room from the user via the user-system interaction module, to store the created navigation map to at least one local carrier, as well as to upload the created navigation map to a system server.

Also, according to the preferable embodiment of the invention, the navigation map creation module comprises a marker arrangement sub-module for arranging the markers in the room according to the created navigation map, thereby creating a grid that allows to control the robot pose during its movement. According to the invention, the marker is a graphical, magnetic or radio marker and it is preferably located on a floor of the room.

According to another preferable embodiment of the invention, the navigation map creation module comprises a robot movement graphs management sub-module that is configured to create paths for movement of the robots in at least one movement direction.

Preferably, creation of the navigation map using the AI algorithms comprises analyzing the desired area for arrangement of the storage containers and movement of the robots, arrangement of the structural elements of the room which are located in the desired area for arrangement of the storage containers and movement of the robots, creating safety zones around the structural elements of the room, where the movement of the robots and at least a part of the storage containers transported by the robots is prevented, with consideration of desired safety parameters, analyzing possible variants of arrangement of the storage containers and additional equipment, calculating a number of paths for movement of the robots and a number of rows of the storage containers that could be arranged between the structural elements of the room, forming optimal paths for movement of the robots, selecting locations for turns of the storage containers, calculating a number of the robots and their movement velocity, and generating a grid for covering the room area, where the movement of the robots is allowed, selected as a result of the input data processing, the room area for arrangement of the storage containers selected as a result of the input data processing, the room area for arrangement of the additional equipment selected as a result of the input data processing.

According to the invention, parameters of cells of the grid, where the movement of the robots with the storage containers is allowed, are calculated as per the following formula

$$CSL = ConSL + SIW * 2 ,$$

where
CSL—length of a side of the grid cell,
ConSL—length of a side of the storage containers,
SIW—width of the safety zone for the robot that is added from both opposite sides of the robots.

Preferably, the grid cells have a rectangular shape, and their interior must be sufficient for movement of the robot together with the storage container. If the storage container has a shape other than square, the length of the sides of the grid cell will be different and it will be calculated according to the length of the sides of the storage container.

Also, according to the invention, the parameters of the grid cells, where the turn of the storage container is allowed when the robot performs a turnaround, are calculated as per the following formula

$$TCSL = \sqrt{( C o n S L {1}^{2} + C o n S L {2}^{2} )} + SIW * 2 ,$$

where
TCSL—length of a side of the cell, where the turn of the storage container is allowed,
ConSL—length of a side of the storage containers,
SIW—width of the safety zone for the robot that is added from both opposite sides of the robots.

The grid cell, where any turns of the storage container are allowed when the robot performs the turnaround, must house a circle that is required for the safe turn of the storage container. Since a space that will be not less than a diagonal of the storage container is required to perform the turnaround of the storage container, the diagonal is calculated as per the Pythagorean theorem and two safety zones is added thereto from both sides of the container.

If the storage container has a shape other than square, then the length of the sides of the grid cell will be different and it will be calculated according to the length of the sides of the storage container.

Operation of the system for controlling the robot pose in the room that is used for performing the claimed method for controlling the robot pose in the room is described below.

The interaction between the user and the navigation map creation module is provided via the user-system interaction module in order to receive the data about the room from the user. The user uploads the corresponding file (.dwg) containing the room plan. Then, the user indicates the structural elements of the building on those area which, in the user's opinion, may be used, e.g., for movement of the robots, namely, walls, footprints of the building, elevator shafts, stationary equipment, slits in the walls, stairwells etc. At the next step, the user indicates the desired area of the room, where the movement of the robots is allowed, the desired area of the room for arrangement of the storage containers, the desired area of the room for arrangement of the additional equipment, e.g., charging stations for the robots, by delineating the desired area on the uploaded plan by means of contour rectangular lines. Then, the user indicates the required number and dimensions of the storage container, the number and dimensions of the additional equipment, e.g., loading and unloading stations which are intended both for manual loading and unloading of goods to or from the container and for automated loading and unloading goods by means of manipulator robots, conveyors etc. Also, the user indicates types and dimensions of the robots and the desired safety parameters, namely, safety zones for the robot-additional distances which are added to the dimensions of the robot which are intended to provide a non-interrupted movement of the robot in case of its deviation during driving from a center of the built path. Then, the user may further indicate a desired throughput that is expected from the system and measured as a number of shipped goods or storage containers per time unit (hour, shift, day etc.).

Then, the received data are processed by means of the navigation map creation module and the navigation map is created based on results of this processing using the AI algorithms.

The AI algorithms analyze the desired area for arrangement of the storage containers and movement of the robots, arrangement of the structural elements of the room which are located in the desired area for arrangement of the storage containers and movement of the robots, create safety zones around the structural elements of the room, where the movement of the robots and at least a part of the storage containers transported by the robots is prevented, with consideration of desired safety parameters, analyze possible variants of arrangement of the storage containers and additional equipment, wherein the user may indicate several possible locations, while the AI, based on its own calculations, selects which one of the indicated locations will be the best in terms of optimization of movement of the robots, calculate a number of paths for movement of the robots and a number of rows of the storage containers that could be arranged between the structural elements of the room, form optimal paths for movement of the robots, select locations for turns of the storage containers, calculate a number of the robots and their movement velocity, and generate a grid for covering the room area, where the movement of the robots is allowed, selected as a result of the input data processing, the room area for arrangement of the storage containers selected as a result of the input data processing, the room area for arrangement of the additional equipment selected as a result of the input data processing.

Parameters of cells of the grid, where the movement of the robots with the storage containers is allowed when the robot doesn't performs a turnaround and moves only straight, are calculated as per the following formula

$$CSL = ConSL + SIW * 2 ,$$

where
CSL—length of a side of the grid cell,
ConSL—length of a side of the storage containers,
SIW—width of the safety zone for the robot that is added from both opposite sides of the robots.

Preferably, the grid cells have a rectangular shape, and their interior must be sufficient for movement of the robot together with the storage container. If the storage container has a shape other than square, the length of the sides of the grid cell will be different and it will be calculated according to the length of the sides of the storage container.

Also, according to the invention, the parameters of the grid cells, where the turn of the storage container is allowed when the robot performs a turnaround, are calculated as per the following formula

$$TCSL = \sqrt{( C o n S L {1}^{2} + C o n S L {2}^{2} )} + SIW * 2 ,$$

where
TCSL—length of a side of the cell, where the turn of the storage container is allowed,
ConSL—length of a side of the storage containers,
SIW—width of the safety zone for the robot that is added from both opposite sides of the robots.

The grid cell, where any turns of the storage container are allowed when the robot performs the turnaround, must house a circle that is required for the safe turn of the storage container. Since a space that will be not less than a diagonal of the storage container is required to perform the turnaround of the storage container, the diagonal is calculated as per the Pythagorean theorem and two safety zones is added thereto from both sides of the container.

If the storage container has a shape other than square, then the length of the sides of the grid cell will be different and it will be calculated according to the length of the sides of the storage container.

Based on the grid generated during creation of the navigation map, the markers are arranged in the room, preferably, on the floor, for controlling the arrangement of the robots in the room by receiving the data from said markers, as well as the data received by at least one sensor mounted in the robot upon its interaction with at least one marker, and this data is compared to the created navigation map by means of the location control module for controlling the location of at least one robot in the room.

In case of integration with the third-party systems, e.g., a warehouse or manufacturing facility control system, the third-party system is aware of a target location for moving a good being present in the storage container, and a robot location control system in the room has a data about a location of the storage container with the required good and is configured to determine the optimal path for moving the storage container from one point to another one. Therefore, the warehouse or manufacturing facility control system indicates the target location for moving the good in the storage container, and the robot location control system in the room which is aware of the location of this storage container selects the robot and the optimal path for moving the storage container and provides the robot with a command for executing the task received from the third-party control system.

Therefore, the system for controlling the robot pose in the room is provided, the system having the set of interrelated elements that allows to provide achievement of the technical effect being simplification of interaction between the user, the system and robots, the provision of its flexibility if quick adaptation to any alterations of the operation process is needed. Also, the method for controlling the robot pose in the room is provided, the method having the combination of steps, while said combination and the set of the interrelated elements of the system used for its implementation allows to provide the achievement of the above-mentioned technical effect.

1. A system for controlling a robot pose in a room, the system comprises
a navigation map creation module for creating a navigation map that corresponds to an interior of the room and is for at least one robot that is configured to alter its pose in the room according to the created navigation map,
a location control module for controlling a location of at least one robot in the room, the module is configured to receive a data from markers located in the room according to the created navigation map, as well as a data received by at least one sensor mounted in the robot upon its interaction with at least one marker,
and a user-system interaction module that is configured to enable an interaction between a user and the navigation map creation module and the location control module for controlling the location of at least one robot in the room,
wherein
the navigation map creation module is configured to receive an input data about the room from the user via the user-system interaction module, to process the received data and to create the navigation map based on results of this processing using artificial intelligence (AI) algorithms.

2. The system according to claim 1, wherein the room is a storage room.

3. The system according to claim 2, wherein the robot is configured to alter its pose in the storage room to move storage containers.

4. The system according to claim 1, wherein the system comprises a third-party control systems integration module that is configured to enable the user to input an input data and to receive an output data from third-party control systems.

5. The system according to claim 1, wherein the input data about the room is selected from a group comprising at least one of a room plan, room structural elements, a desired area of the room, where the movement of the robots is allowed, a desired area of the room for arranging an additional equipment, a number and dimensions of the storage containers, a number and dimensions of the additional equipment, a type and dimensions of the robots, desired safety parameters.

6. The system according to claim 1, wherein the navigation map creation module comprises a file management sub-module that is configured to upload files about the room during receiving the input data about the room from the user via the user-system interaction module, to store the created navigation map to at least one local carrier, as well as to upload the created navigation map to a system server.

7. The system according to claim 1, wherein the navigation map creation module comprises a marker arrangement sub-module for arranging the markers in the room according to the created navigation map.

8. The system according to claim 7, wherein the marker is a graphical, magnetic or radio marker.

9. The system according to claim 7, wherein the marker is arranged on a floor of the room.

10. The system according to claim 1, wherein the navigation map creation module comprises a robot movement graphs management sub-module that is configured to create paths for movement of the robots in at least one movement direction.

11. A method for controlling a robot pose in a room by means of the system according to claim 1, the method comprises the following steps of
creating, by means of a navigation map creation module, a navigation map that corresponds to an interior of the room and is for at least one robot that is configured to alter its pose in the room according to the created navigation map,
controlling, by means of a location control module for controlling a location of at least one robot in the room, a location of at least one robot in the room by receiving a data from markers located in the room according to the created navigation map, as well as a data received by at least one sensor mounted in the robot upon its interaction with at least one marker, and by comparing this data to the created navigation map,
and each step comprises enabling a user interaction with the navigation map creation module and with the location control module for controlling the location of at least one robot in the room by means of a user-system interaction module,
wherein
the step of creating the navigation map comprises enabling receiving an input data about the room from the user, processing the received data and creating the navigation map based on results of this processing using AI algorithms by means of the navigation map creation module.

12. The method according to claim 11, wherein a storage room is used as the room.

13. The system according to claim 11, wherein a robot that is configured to alter its pose in the storage room to move storage containers is used as the robot.

14. The method according to claim 11, wherein it comprises a step of performing an interaction with third-party control systems by enabling the user to input an input data and to receive an output data from the third-party control systems by means of a third-party control systems integration module.

15. The method according to claim 11, wherein the input data about the room is selected from a group comprising at least one of a room plan, room structural elements, a desired area of the room, where the movement of the robots is allowed, a desired area of the room for arranging an additional equipment, a number and dimensions of the storage containers, a number and dimensions of the additional equipment, a type and dimensions of the robots, desired safety parameters.

16. The method according to claim 11, wherein the navigation map creation module is provided by a file management sub-module that is configured to upload files about the room during receiving the input data about the room from the user via the user-system interaction module, to store the created navigation map to at least one local carrier, as well as to upload the created navigation map to a system server.

17. The method according to claim 11, wherein the navigation map creation module is provided by a marker arrangement sub-module for arranging the markers in the room according to the created navigation map.

18. The method according to claim 17, wherein a graphical, magnetic or radio marker is used as the marker.

19. The method according to claim 17, wherein the marker is arranged on a floor of the room.

20. The method according to claim 11, wherein the navigation map creation module is provided by a robot movement graphs management sub-module that is configured to create paths for movement of the robots in at least one movement direction.

21. The method according to claim 15, wherein the creation of the navigation map comprises analyzing the desired area for arrangement of the storage containers and movement of the robots, arrangement of the structural elements of the room which are located in the desired area for arrangement of the storage containers and movement of the robots, creating safety zones around the structural elements of the room, where the movement of the robots and at least a part of the storage containers transported by the robots is prevented, with consideration of desired safety parameters, analyzing possible variants of arrangement of the storage containers and additional equipment, calculating a number of paths for movement of the robots and a number of rows of the storage containers that could be arranged between the structural elements of the room, forming optimal paths for movement of the robots, selecting locations for turns of the storage containers, calculating a number of the robots and their movement velocity, and generating a grid for covering the room area, where the movement of the robots is allowed, selected as a result of the input data processing, the room area for arrangement of the storage containers selected as a result of the input data processing, the room area for arrangement of the additional equipment selected as a result of the input data processing.

22. The method according to claim 21, wherein parameters of cells of the grid, where the movement of the robots with the storage containers is allowed, are calculated as per the following formula
$$CSL = ConSL + SIW * 2 ,$$
CSL—length of a side of the grid cell,
ConSL—length of a side of the storage containers,
SIW—width of the safety zone for the robot that is added from both opposite sides of the robots.

23. The method according to claim 21, wherein parameters of cells of the grid, where the turn of the storage container is allowed, are calculated as per the following formula
$$TCSL = \sqrt{( C o n S L {1}^{2} + C o n S L {2}^{2} )} + SIW * 2 ,$$
where
TCSL—length of a side of the cell, where the turn of the storage container is allowed,
ConSL—length of a side of the storage containers,
SIW—width of the safety zone for the robot that is added from both opposite sides of the robots.
